(19) United States
(12) Patent Application Publication
(10) Pub. No.: US 2003/0005758 A1
(43) Pub. Date: Jan. 9, 2003

(54) Tire gauge

(76) Inventor: John Timothy Dotson, Coppell, TX (US)

Correspondence Address: Robert H. Johnston III, P.O. Box 121183, Arlington, TX, 76012, US

(21) Appl. No.: 10/186,451

(22) Filed: Jul. 1, 2002

Related U.S. Application Data
(60) Provisional application No. 60/303,161, filed on Jul. 3, 2001.

(51) Int. Cl. G01M 17/02

(52) U.S. Cl. 73/146

(57) ABSTRACT

A tire gauge for measuring a pressurized gas in a tire through a valve stem includes a pressure-measuring device for receiving the pressurized gas and determining a pressure measurement for the pressurized gas and an attachment-and-alignment mechanism coupled to the pressure-measuring device for aligning the tire gauge with the tire valve stem and for removably coupling the tire gauge to the tire valve stem while activating the needle valve in the tire valve stem. A method is also presented.

### RELATED PATENT APPLICATION

This application claims priority of U.S. Provisional Application No. 60/303,161, filed Jul. 3, 2001, entitled, “tire gauge.”

### TECHNICAL FIELD OF THE INVENTION

The present invention relates to pressure measuring devices and more particularly to a tire gauge that readily aligns and attaches to a tire valve stem.

### BACKGROUND OF THE INVENTION

To obtain maximum performance and safety from tires, especially automobile tires, they must be properly inflated. Accordingly, there is a need to measure the pressure in the tires. Many forms of tire pressure gauges have been produced for this purpose.

One popular type for car tires is the tubular body gauge that has a slide bar that allows the pressure to be measured. Such a gauge is shown with some enhancements in U.S. Pat. No. 4,526,030, which is entitled “multi-functional tire testing tool.”

Tire gauges may also include sophisticated electronics to digitally measure the pressure. For example, U.S. Pat. No. 4,998,438, which is entitled “digital air pressure gauge and inflation device” and which is incorporated herein by reference for all purposes, shows such a gauge that further includes an ear for attaching the gauge. The pressure is measured by gauge G in casing C and displayed digitally on window 10. Other digital gauges are found in U.S. Pat. Nos. 4,250,759; 4,704,901; 4,748,845, and Des. Pat. No. 409,931, all of which are incorporated herein by reference for all purposes.

Among the challenges in using conventional tires gauges are the need to align the gauge with the valve stem and properly hold the gauge in position. Also, because tire pressure should be checked fairly frequently, the ease and speed offered by a tire gauge design remain important considerations.

### SUMMARY OF THE INVENTION

Therefore, a need has arisen for a tire gauge that addresses shortcomings of conventional tire gauges. According to an aspect of the present invention, a tire gauge for measuring a pressurized gas in a tire through a valve stem includes a pressure measuring device for receiving the pressurized gas and determining a pressure measurement for the pressurized gas and an attachment-and-alignment mechanism coupled to the pressure measuring device for aligning the tire gauge with the valve stem and for removably coupling the tire gauge to the valve stem.

According to another aspect of the present invention, a tire gauge is provided that includes a tubular body with a slide bar and a pressure-receiving a passageway or channel and further includes an activation collar having a plurality of activation slots, a gripping collar having a plurality of cam slots with a plurality of gripping cams in each and with the activation collar mated over the gripping collar. The gripping collar is attached to the pressure-receiving channel of the tire gauge, and a trigger arm is attached to the gauge such that when the trigger arm is activated it causes the activation collar to move relative to the gripping collar whereby the gauge aligns and attaches to the tire stem while activating the needle valve of the tire stem.

According to another aspect of the present invention, a tire gauge is provided that includes a tire gauge body having an alignment channel, a trigger, and a plurality of gripping arms wherein activation of the trigger causes the gripping arms to come together and inboard so as to grab and pull the tire stem further into the alignment channel and thereby align, attach, and activate the tire valve stem.

A method of manufacturing a tire gauge for measuring air pressure communicated through a tire stem includes the steps of: providing a pressure measuring device having a pressure-receiving passageway; attaching an alignment-and-attachment device to the pressure-receiving passageway such that when activated, the gauge will align and attach to a tire stem while simultaneously activating the needle valve in the tire stem.

The present invention provides advantages; a number of examples follow. An advantage of the present invention is that the tire gauge essentially aligns itself during activation of the gauge. Another advantage is that the tire gauge properly attaches and seals about the valve stem when activated. Another advantage is that the tire gauge is securely held in place on the tire stem with multiple contact points. Another advantage is that the tire gauge typically forms a seal on the first attempt and thereby saves a user time.

### BRIEF DESCRIPTION OF THE DRAWINGS

For a more complete understanding of the present invention and advantages thereof, reference is now made to the following description taken in conjunction with the accompanying drawings in which like reference numbers indicate like features, and wherein:

FIG. 1 is a schematic, perspective view of a tire gauge according to an aspect of the present invention;

FIG. 2 is schematic, perspective view of an activating collar of a tire gauge according to the embodiment of the invention in FIGS. 2-5;

FIG. 3 is schematic, perspective view of gripping collar of a tire gauge according to the embodiment of the invention in FIGS. 2-5;

FIG. 4 is a schematic, perspective view of a gripping collar and activation collar immediately before combining them for the embodiment of the invention in FIGS. 2-5;

FIG. 5 is schematic, perspective view of primarily an assembled alignment-and-attachment device of a tire gauge according to the embodiment of the invention in FIGS. 2-5;

FIG. 6 is a schematic, perspective view of a digital tire gauge according to another embodiment of the present invention;

FIG. 7 is a schematic, perspective view with portions broken away of a portion of the tire gauge of FIG. 6; and

FIG. 8 is a schematic diagram showing conceptual how two gripping arms 232, 234 cooperate with tracks 249 and 250 to grip and pull stem 212.

### DETAILED DESCRIPTION OF THE INVENTION

The preferred embodiment of the present invention and its advantages are best understood by referring to FIGS. 1-8 of the drawings, like numerals being used for like and corresponding parts of the various drawings.

Referring to FIG. 1, a tire gauge 10 according to the present invention is presented. The tire gauge 10 is made for attaching to a tire valve stem 12 and activating a needle valve (not shown) in the tire stem. As an important feature of the tire gauge 10, it includes an alignment-and-attachment device 14. When activated, such as by its trigger arm 16, the alignment-and-attaching device 14 aligns with and grips the valve stem 12 while activating the needle valve therein. Trigger arm 16 includes a first end 18 and a second end 20 with a middle portion 22 therebetween. The alignment-and-attachment device 14 mates with a pressure-measuring device 24, which is the working portion of the tire gauge 10 that determines a pressure when it receives a pressurized gas in a proper manner. When the valve stem is opened, the pressure-measuring device 24 allows the pressure of the gas communicated through the valve stem to be measured. In the embodiment shown, the pressure measurement device 24 includes a conventional tubular body 26 having a slide bar 28 therein. The slide bar 28 slides out of the tubular body 26 to indicate the pressure.

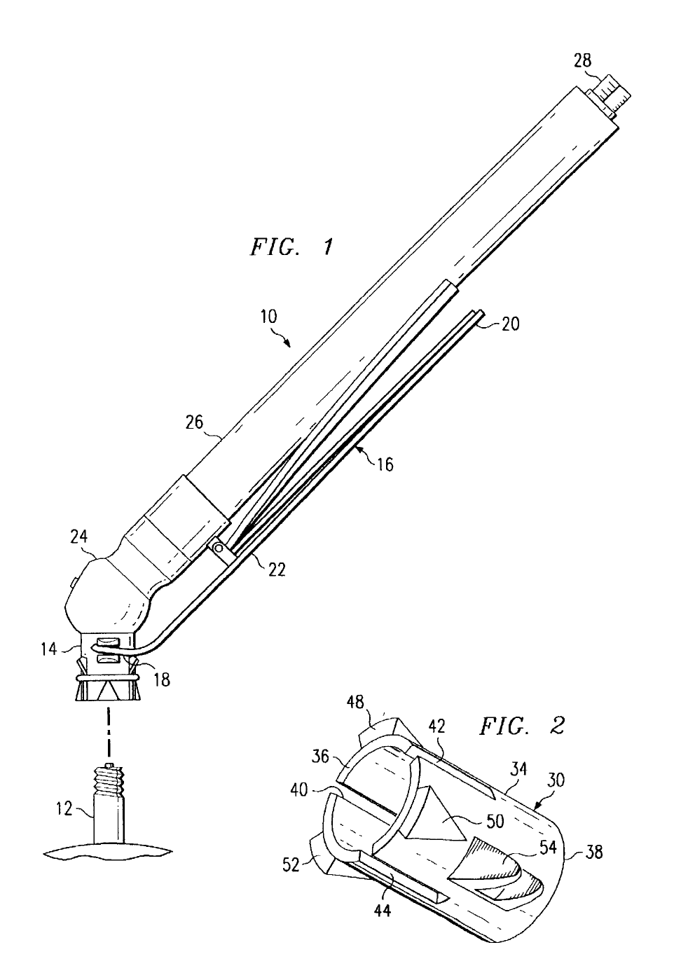

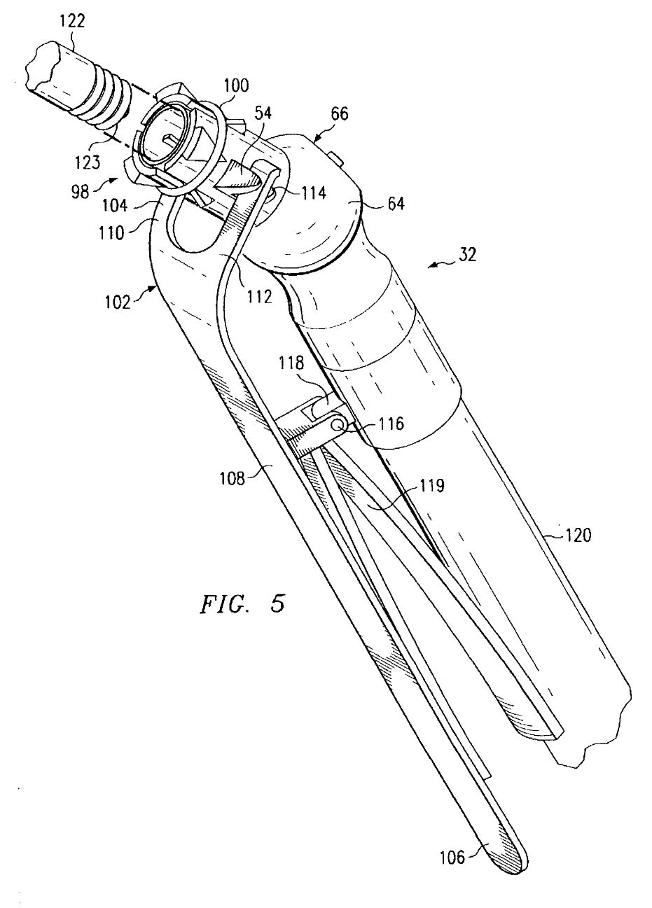

One specific embodiment of the present invention will now be presented with reference to FIGS. 2-5 and initially to FIG. 2. An activating collar 30 that is used in making part of a tire gauge 32 (FIG. 5) is formed with a first cylindrical body 34. The cylindrical body 34 has a first end 36 and a second end 38. On the first end 36 there are plurality of activation slots, such as activation slots 40, 42, and 44. The cylindrical body 34 may be made of numerous materials such as hard plastics, aluminum, or stainless steel.

A plurality of spring retention wedges, such as wedges 48, 50, and 52 are attached near the first end 36 of the activation collar 30 preferably in a spaced relationship. The wedges 48, 50, 52 may be attached by any means known in the art, but preferably by adhesives or epoxies. A trigger arm contact member 54 is attached on an exterior portion of the cylindrical body 34 of activating collar 30. As will be described further below, the trigger arm contact 54 allows the activation collar 30 to move in response to movement of the trigger arm 102 (FIG. 5).

Referring now to FIG. 3, there is shown a gripping collar 60 and a pressure-measuring device 66. The collar 60 has a first end 61 and a second end 63. The second end 63 of collar 60 will be attached to head 64 in alignment with a pressure-receiving channel 62 of the pressure-measuring device 66. The pressure-receiving channel has a rubber seal (not shown), which is essentially a rubber washer around rod 124, in the channel that forms an air-tight seal with a rim portion 123 of a tire valve stem 122 (FIG. 5) when it is placed in the channel 62 and the gauge 32 is activated.

The gripping collar 60 is formed of a second cylindrical body 68. The second cylindrical body may be formed of the same materials as the first cylindrical body 34. When in place, the cylindrical body 68 aligns and positions the tire stem 122 so that pressure from the tire stem 122 is communicated to the pressure-receiving channel 62. This allows the pressure-measuring device 64 to measure the pressure. The cylindrical body 68 is formed with a plurality of cam or finger slots, such as slots 70, 72, and 74. The cylindrical body 68 is also formed with a retainer or pivot groove 76 located at approximately a middle portion of the cam slots 70, 72, and 74, and extending circumferentially about the cylindrical body 68.

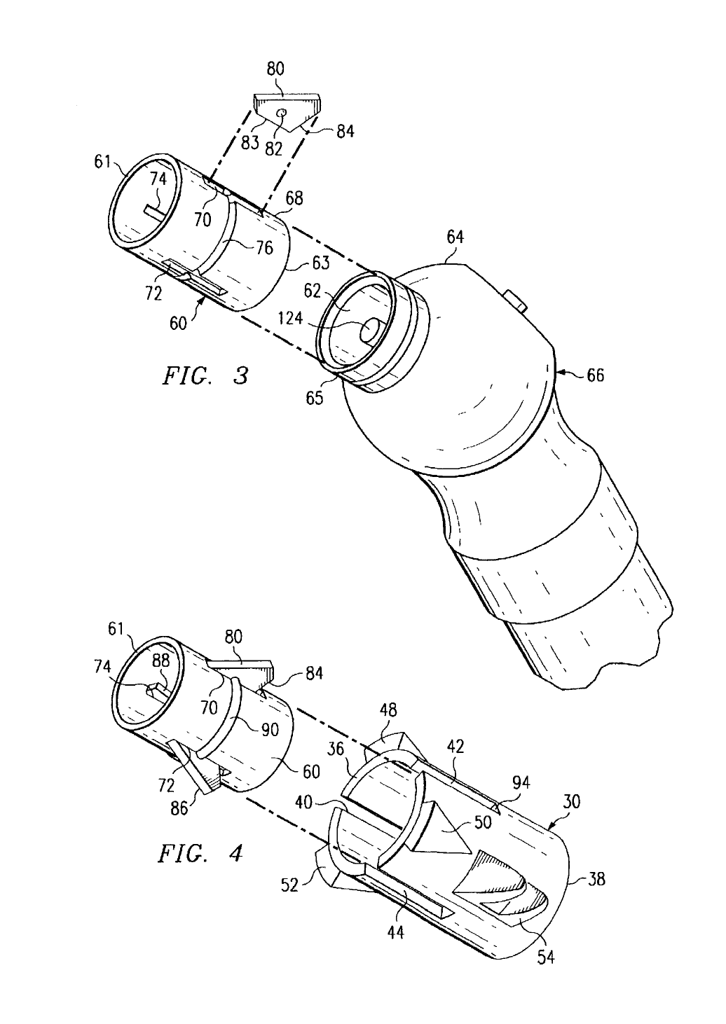

A plurality of gripping cams or fingers, such as gripping cam or finger 80, are provided in a one-to-one correspondence with the cam slots 70, 72, and 74. The gripping cams 80 (also 86 and 88 if FIG. 4) are formed with a pivot aperture 82 through them. The cams 80, 86, and 88 are sized and configured to extend through the cam slots 70, 72, and 74 and are a shaped such that that a first portion 83 (described later as being inboard of the pivot aperture 82) will grip the tire stem 122 as portion 83 is forced against the tire stem 122—the curvature pulls it in and increases the wedging force on it. The portion 83 will be forced against the tire stem 122 as the second portion 84 (described elsewhere as the outboard portion with respect to the pivot aperture) is forced counter-clockwise for the orientation shown in FIG. 3 by a part, e.g., end 94, of activation collar 30 (FIG. 4).

Referring to FIG. 4, the gripping collar 60 is shown with gripping cam 80 disposed within slot 70, gripping cam 86 disposed within cam slot 72, and gripping cam 88 disposed within slot 74. The gripping cams 80, 86, and 88 are held within their respective slots 70, 72, and 74 by a retaining ring 90 that extends through each of their pivot apertures 82. The retaining ring 90 preferably fits snugly within the retainer groove 76. The retaining ring 90 may be made of spring steel or any other material suitable for use as spring or retainer.

As suggested by FIG. 4, the gripping collar 60 has an outside diameter that is less than the inside diameter of activation collar 30; activation collar 30 is sized and configured to extend over the exterior of the gripping collar 60 as suggested by hidden lines in FIG. 4. When the activation collar 30 is mated with the gripping collar 60, the plurality of activation slots will mate with the plurality of gripping cams in a one-to-one fashion; for example, activation slot 42 will be moved relative to gripping cam 80 such that cam 80 will be moveable within slot 42.

When the tire gauge 32 is activated, the activation collar 30 will slide relative to the gripping collar 60 such that the ends, e.g., end 94, of each activation slot will press against a portion (e.g., portion 84 of cam 80) of each gripping cam causing it to want to rotate about the retaining ring 90 counter-clockwise for the orientation shown. This causes the first portion of each cam, e.g., portion 83 of cam 80, to rotate toward an interior portion of the gripping collar 60. This rotation causes the cam portion 83 to engage the tire stem 122 and seals the rim 123 against a rubber seal in pressure-receiving channel 62. As it pulls inward, the rim 123 is pulled tighter against the seal in channel 62.

Referring to FIG. 5, there is shown a perspective view of completed alignment-and-activation device 98 of tire gauge 32. Once the activation collar 30 and gripping collar 60 have been mated such as discussed in connection with FIG. 4, a cam-retaining spring or ring 100 is placed securely against the retention wedges 48, 50, and 52. The ring 100 may be made of spring steel or other suitable material for a retainer. The cam retainer spring 100 helps to maintain the gripping cams 80, 86, and 88, in their proper position. The second end 63 of the gripping collar 60 is attached to an exterior 65 of channel 62. A trigger arm 102 is also attached to the tire gauge 32.

The trigger arm 102 has a first end 104, a second end 106, and a middle portion 108. In this embodiment, the first end 104 of the trigger arm 102 has two portions or fingers 110 and 112. Finger 112 rests within an interior portion 114 of trigger arm contact 54 and the second or other finger 110 rests in another trigger arm contact attached to the activation collar 30 on the opposite side of contact 54. The trigger arm 102 is pivotably coupled at pivot 116 to a pivot arm 118. The pivot connection 116 includes a biasing spring 119 that urges clockwise rotation of arm 102 (for the orientation shown).

With this trigger arm arrangement, when a user causes the second portion 106 of the trigger arm 102 to be moved closer to the tubular body 120 of tire gauge 32, the first end 104 of arm 102 moves and impinges on the trigger arm contacts 54 and causes the activation collar 30 to move relative to the gripping collar 60 as previously discussed. Thus this activation of the trigger arm 102 will cause the tire gauge to align, attach, and seal the tire stem 122. With respect to the valve activation, a valve activation member 124 (FIG. 3) engages a needle-valve-activating-member within the tire stem 122 to cause the valve to open. Both the valve activation member 124 and the length (measured between first end 36 and second end 38) of the activation collar 30 are sized to properly engage the valve stem 122. It will be apparent that the inside diameter of the gripping collar 60 is larger than the outside diameter of the valve stem 122.

To use the tire gauge 32, the user places the tire gauge 32 on the tire stem 122 with the stem 122 extending into the gripping collar 60 and with the rim 123 rest against the seal inside channel 62. The trigger arm 102 is then used to activate the gauge 32 by pulling the second end 106 toward the tubular body 120. As described above, this will cause the gripping cams 80, 86, and 88 to further align the stem 122 inside the gripping collar 60 while sufficiently pulling the tire stem 122 into the gripping collar 60 to cause rod 124 to activate the needle valve and while the cams 80, 86, and 88 impinge adequately against the stem 122 to hold it securely in place.

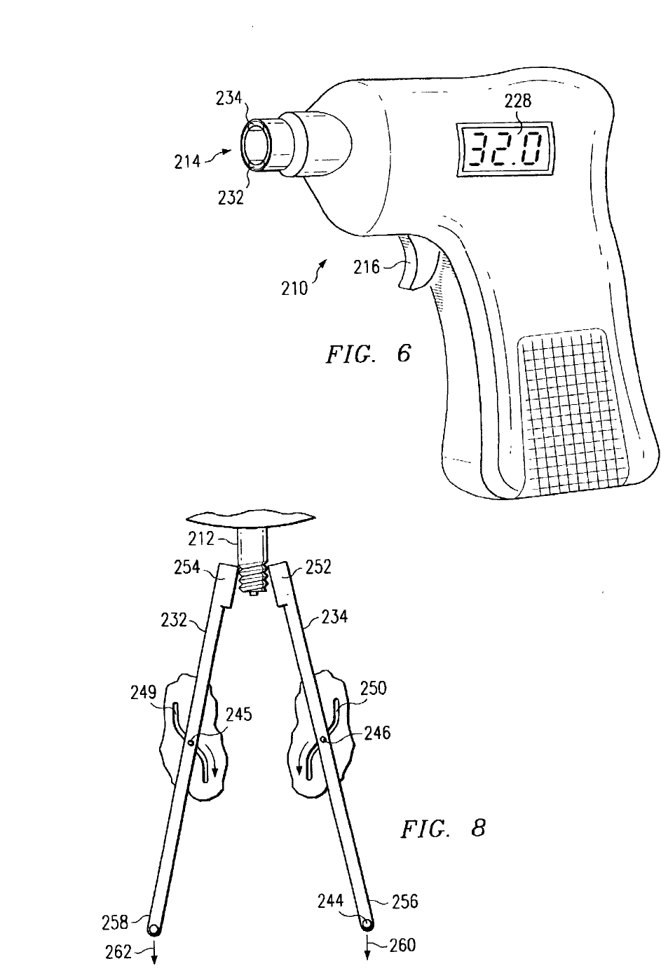

Referring now to FIGS. 6-8, another embodiment of a tire gauge 210 is presented, but this one is a digital embodiment. Tire gauge 210 is designed to align and attach a tire valve stem 212, activate the valve, and communicate the pressure of a pressurized gas in the tire to a pressure-measuring device 224. The pressure-measuring device measures the pressure of the pressurized gas and displays it on external display 228. Acceptable circuitry and transducers for measuring and displaying the pressure are known in the art; for example, see U.S. Pat. Nos. 4,250,759; 4,704,901; and 4,748,845, all of which are incorporated herein by reference for all purposes.

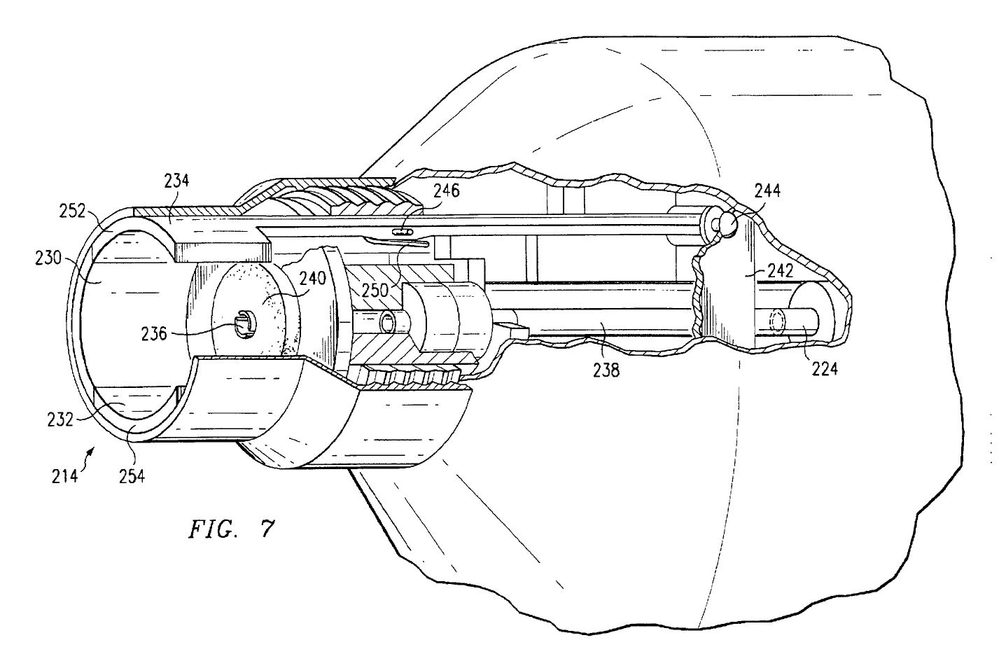

When trigger 216 is activated by the operator pulling it while the valve stem 212 is located inside an alignment channel 230, a first gripping arm 232 and a second gripping arm 234 are activated to essentially pinch and pull the stem 212—this aligns and attaches the valve stem 212 and activates the needle valve in the valve stem 212. The valve stem 212 is activated by activation channel or member 236, which activates the valve and receives the air pressure and delivers it into a pressure-receiving passageway or tube 238 that communicates the pressure to the pressure-measuring device 224. When the valve stem 212 is being forced by the gripping arms 232 and 234 against the activation channel or member 236, it is also being pressed against a sealing washer 240, which is preferably a soft rubber material or the like. As will be described in more detail further below, FIG. 8 is a schematic diagram to demonstrate the concept of the operation of arms 232 and 234.

Referring specifically to FIG. 7, when trigger 216 is activated, it causes—through a series of gears—a carriage 242 to be moved; with reference to FIG. 7, it would move carriage 242 to the right as shown in that figure. Gripping arms 232 and 234 are secured to carriage 242 by pins; for example, arm 234 by pin 244. Each gripping arm 232, 234 has an extending pin, such as pin 246 shown on arm 232. The extending pins 246 each mate with a track or defined channel, such as channel 250. As carriage 242 moves to the right in FIG. 7, the extending pins, e.g., pin 246, follow the tracks and that causes the first end 252 of gripping arm 234 and the first end 254 of gripping arm 232 to come together and to move slightly inboard into the tire gauge 210 (i.e., to the right in FIG. 7). This action of the gripping arms is better shown conceptually in FIG. 8.

With reference to FIG. 8, an exaggerated alignment of gripping arms 232 and 234 are shown. Valve stem 212 is placed near first ends 252, 254 of the arms 232, 234. The second ends 256 and 258 are attached to a carriage 242 (FIG. 7), which moves in the direction shown by arrows 260, 262 when the trigger 216 (FIG. 6) of the tire gauge 210 is activated. As arms 232, 234 move, the extending pins 246 and 245 move in their respective tracks 249 and 250. As will be apparent in FIG. 8, as the pins 245 and 246 move in the tracks 249 and 250, it causes the members 232 and 234 to come closer together, bringing the ends 252, 254 together while simultaneously moving them in the direction of arrows 260 and 262. As it does this, it moves the entire stem 212 further into the alignment channel 230 and up against the activation channel 236. An airtight seal is formed between the valve stem 212 and a sealing member 240, which is preferably made of a pliable rubber-like material. The pressure is then delivered to tube 238, which fluidly communicates the pressure to a pressure-measuring device 224.

In operation, the valve stem 212 is placed in opening or channel 230 of tire gauge 210, and then the trigger 216 is pulled. This causes the arms 232 and 234—in cooperation with channel 230, to align and attach the tire gauge 210 and valve stem 212. Thus the arms 232 and 234 and channel 230 serve as an attachment-and-alignment device for gauge 210. The activation channel or passageway 236 simultaneously activates the needle valve in stem 212 and delivers the pressure via passageway 238 to pressure-measuring device 224. The pressure is determined by device 224 and displayed on display 228.

Although the present invention and its advantages have been described in detail, it should be understood that various changes, substitutions and alterations can be made therein without departing from the spirit and scope of invention as defined by the appended claims. As an example of one other embodiment, an alignment-and-attachment device may be coupled to a digital pressure-measuring device instead of a conventional tube-and-slide type pressure-measuring device. In addition, while a gripping cam and cam slot arrangement within a collar has been presented in the embodiment of FIGS. 2-5 as the alignment-and-attachment mechanism, other designs can be used; for example, teeth or coupling collars might be used to grab a portion of the tire stem and pull the tire valve stem into the pressure-measuring device. As another example, the trigger may activate a motor that causes the alignment-and-attachment mechanism to engage the tire stem.

What is claimed is:

1. A tire gauge for measuring a pressurized gas when the pressurized gas is in fluid communication with the tire gauge through a tire valve stem, the tire gauge comprising:
a pressure-measuring device for receiving the pressurized gas and determining a pressure measurement for the pressurized gas; and
an attachment-and-alignment mechanism coupled to the pressure-measuring device for aligning the tire gauge with the valve stem and for removably coupling the tire gauge to the tire valve stem.

2. The tire gauge of claim 1 wherein the attachment-and-alignment mechanism comprises:
an activation collar, wherein the activation collar includes:
a first cylindrical body having a first end and a second end and formed with a plurality of activation slots proximate the first end,
a plurality of spring retention wedges attached to the first cylindrical body proximate the first end, and
at least one trigger arm contact member coupled to an exterior portion of the first cylindrical body;
a gripping collar, wherein the gripping collar includes:
a second cylindrical body having a first end and a second end, a plurality of cam slots and a retainer groove formed in the second cylindrical body,
a plurality of gripping cams each formed with a pivot aperture and each disposed within the plurality of cam slots in a one to one fashion, and
a retaining ring disposed through the pivot apertures of the gripping cams and at least partially disposed within the retainer groove;
wherein the activation collar is mated over the gripping collar and the gripping collar is attached to the pressure-receiving passageway of the tire gauge;
a pivot arm attached to the tubular body of the tire gauge; and
a trigger arm having a first end, a middle portion, and a second end, the trigger arm pivotably coupled to the pivot arm proximate the middle portion and is sized and configured such that the first end of the pivot arm interfaces with the trigger arm contact, such that when the second end of the trigger arm is pivoted about the pivot arm, the first end of the trigger arm applies a force upon the trigger arm contact causing the activation collar to move relative to the gripping collar whereby the tire gauge is operable to align and removably attach to a valve stem.

3. The tire gauge of claim 1 further comprising a tire gauge body formed with an alignment channel on one end, a trigger that when pulled initiates movement of the attachment-and-alignment mechanism, a carriage moveably coupled to the tire gauge body so as be moveable when the trigger is activated, and wherein the attachment-and-alignment mechanism comprises:
a plurality of gripping arms having a first end and a second end and a medial portion therebetween, the second ends attached to the moveable carriage;
a plurality of extending pins, each extending pin coupled in a one-to-one fashion with the plurality of gripping arms and on the medial portion of each such gripping arm;
a track formed on a portion of the tire gauge body and wherein the tracks are sized and configured to mate with a portion of the extending pins and to cause relative movement of the gripping arms when each gripping arm is caused to moved in a direction substantially parallel to the tracks;
wherein the first ends of the plurality of gripping arms are disposed within in the alignment channel; and
wherein activation of the trigger causes the extending pins to move in the tracks and thereby causes the gripping arms to move closer to each other so to grip and align a tire stem if found in the space between the first ends of the plurality of gripping arms.

4. The tire gauge of claim 1 wherein the attachment-and-alignment mechanism comprises a means for attaching and aligning a tire stem to the tire gauge.

5. A tire gauge having tubular body with a slide bar and a pressure-receiving passageway, wherein the improvement comprises:
an activation collar, wherein the activation collar includes:
a first cylindrical body having a first end and a second end and formed with a plurality of activation slots proximate the first end,
a plurality of spring retention wedges attached to the first cylindrical body proximate the first end, and
at least one trigger arm contact member coupled to an exterior portion of the first cylindrical body;
a gripping collar, wherein the gripping collar includes:
a second cylindrical body having a first end and a second end, a plurality of cam slots and a retainer groove formed in the second cylindrical body,
a plurality of gripping cams each formed with a pivot aperture and each disposed within the plurality of cam slots in a one to one fashion, and
a retaining ring disposed through the pivot apertures of the gripping cams and at least partially disposed within the retainer groove;
wherein the activation collar is mated over the gripping collar and the gripping collar is attached to the pressure-receiving passageway of the tire gauge;
a pivot arm attached to the tubular body of the tire gauge; and
a trigger arm having a first end, a middle portion, and a second end, the trigger arm pivotably coupled to the pivot arm proximate the middle portion and is sized and configured such that the first end of the pivot arm interfaces with the trigger arm contact, such that when the second end of the trigger arm is pivoted about the pivot arm, the first end of the trigger arm applies a force upon the trigger arm contact causing the activation collar to move relative to the gripping collar whereby the tire gauge is operable to align and removably attach to a valve stem.

6. A method of manufacturing a tire gauge for measuring air pressure communicated through a tire valve stem, the method comprising the steps of:
providing a pressure-measuring device having a pressure-receiving passageway;
attaching an alignment-and-attachment device to the pressure-receiving passageway of a type that when activated will align and attach the tire gauge to a tire valve stem while simultaneously activating a needle valve in the tire stem.
